(19) United States
(12) Patent Application Publication
(10) Pub. No.: US 2011/0050636 A1
(43) Pub. Date: Mar. 3, 2011

(54) INPUT DEVICE AND DISPLAY DEVICE PROVIDED WITH THE SAME

(75) Inventors: Yasunari Nagata, Higashiomi (JP); Takashi Shimizu, Kirishima (JP); Natsuko Yamagata, Kirishima (JP); Akinori Satou, Kirishima (JP); Takashi Minami, Kirishima (JP); Yoshio Miyazaki, Kirishima (JP)

(73) Assignee: KYOCERA CORPORATION, Kyoto (JP)

(21) Appl. No.: 12/869,943

(22) Filed: Aug. 27, 2010

(30) Foreign Application Priority Data
Aug. 28, 2009 (JP) 2009-198697

(51) Int. Cl. G06F 3/045

(52) U.S. Cl. 345/174

(57) ABSTRACT

An input device has an input region and an outside region positioned outside the input region. The input device includes a base body having translucency, a detection electrode configured to detect an input position, and a wiring conductor configured to apply a voltage to the detection electrode. The detection electrode is provided in the input region and on the base body. The wiring conductor is provided in the outside region and on the base body. The input device further includes an insulation film which covers the wiring conductor and is provided in the outside region, and a conductor film provided on the insulation film so as to be opposed to the wiring conductor in a thickness direction of the insulation film.

### BACKGROUND OF THE INVENTION

1. Field of the Invention

The present invention relates to an input device and a display device provided with the same.

2. Description of the Related Art

An input device is provided with a detection electrode to detect an input position, and a wiring conductor to apply a voltage to this detection electrode, on a base body (see Japanese Patent Application Laid-Open No. 8-328721, for example).

Recently, the input device is required to be improved in detection accuracy of an input position.

The present invention has been made in this respect, and it is an object of the present invention to improve detection accuracy of an input position.

### SUMMARY OF THE INVENTION

An input device according to one embodiment of the present invention has an input region and an outside region positioned outside the input region. The input device includes a base body having translucency, a detection electrode configured to detect an input position, and a wiring conductor configured to apply a voltage to the detection electrode. The detection electrode is provided in the input region and on the base body. The wiring conductor is provided in the outside region and on the base body. The input device further includes an insulation film which covers the wiring conductor and is provided in the outside region, and a conductor film provided on the insulation film so as to be opposed to the wiring conductor in a thickness direction of the insulation film.

### BRIEF DESCRIPTION OF THE DRAWINGS

FIG. 1 is a plan view showing an input device according to a first embodiment of the present invention;

FIGS. 2A and 2B are cross-sectional views of the input device shown in FIG. 1, in which FIG. 2A is the cross-sectional view taken along a line Ib-Ib, and FIG. 2B is the cross-sectional view taken along a line IIb-IIb;

FIG. 3 is a cross-sectional view of the input device shown in FIG. 1 taken along a line IIIb-IIIb in FIG. 1;

FIGS. 4A to 4F are cross-sectional views showing production steps of the input device shown in FIG. 1 taken along a line IIIb-IIIb in FIG. 1;

FIGS. 5A and 5B are plan views showing a region in which a wiring insulation film and a conductor film of the input device shown in FIG. 1 are formed;

FIG. 6 is a cross-sectional view showing a display device according to an embodiment of the present invention;

FIG. 7 is a perspective view showing a liquid crystal display panel;

FIG. 8 is a cross-sectional view showing an essential part of an input device according to a second embodiment of the present invention;

FIG. 9 is a cross-sectional view showing an essential part of a variation of the input device according to the embodiment of the present invention; and

FIG. 10 is a cross-sectional view showing an essential part of another variation of the input device according to the embodiment of the present invention.

### DESCRIPTION OF THE PREFERRED EMBODIMENTS

### First Embodiment

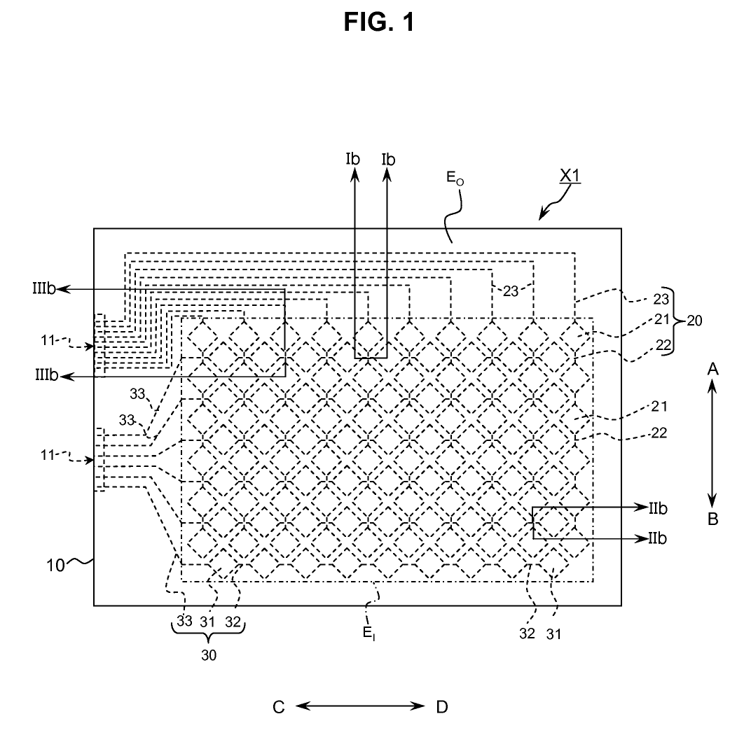

Referring to FIGS. 1 to 3, an input device X1 according to a first embodiment of the present invention is described.

The input device X1 is a capacitance type touch panel. As shown in FIGS. 1 to 3, the input device X1 includes a base body 10, a first detection electrode pattern 20, a second detection electrode pattern 30, and an electrode insulation film 40, a wiring insulation film K, and a conductor film H.

As shown in FIG. 1, the input device X1 has an input region E_{I} which a user touches with a finger and the like to input information, and an outside region E_{O} positioned outside the input region E_{I}. The outside region E_{O} includes an external connection region 11 serving as a region electrically connected to a FPC (Flexible Printed Circuit) provided outside the drawing.

The base body 10 supports the first detection electrode pattern 20, the second detection electrode pattern 30, the electrode insulation film 40, the wiring insulation film K, and the conductor film H. The base body 10 has a lower main surface on which the first and the second detection electrode patterns 20 and 30 etc. are formed, and an upper main surface which a user touches with a finger or an input tool such as a touch pen in order to input information. Thus, a user can input information with a finger or an input tool through the base body 10 without directly touching the first detection electrode pattern 20 and the second detection electrode pattern 30. In this embodiment, the base body 10 is in the shape of a rectangle in planar view, but not limited to such a shape. The base body 10 is formed of a material having translucency and insulation properties such as glass or plastics. Here, the translucency means that it transmits visible light.

The first detection electrode pattern 20 has a first detection electrode 21, a first connection electrode 22, and a first wiring conductor 23.

The first detection electrode 21 has a role to detect a position of a finger F moving closer to the input device X1 in an arrow direction CD. The first detection electrode 21 is provided in the input region E_{I} and provided on the base body 10. The first detection electrodes 21 are arranged along an arrow direction AB and the arrow direction CD at intervals in the shape of a matrix, and the first detection electrodes 21 adjacent to each other in the arrow direction AB are electrically connected to each other by the first connection electrode 22. As shown in FIG. 1, the first detection electrode 21 is in the shape of a diamond in planar view, but not limited to such a shape. The first detection electrode 21 is formed of a material having translucency and conductivity such as ITO (Indium Tin Oxide), IZO (Indium Zinc Oxide), ATO (Antimony Tin Oxide), tin oxide, or zinc oxide.

The first detection electrode 21 is formed as follows. First, an ITO film is formed on the base body 10 by a sputtering method, evaporation method, or chemical vapor deposition (CVD) method. Then, a photosensitive resin is applied onto the ITO film, and the film is patterned through exposing, developing, etching steps, whereby the first detection electrode 21 is formed.

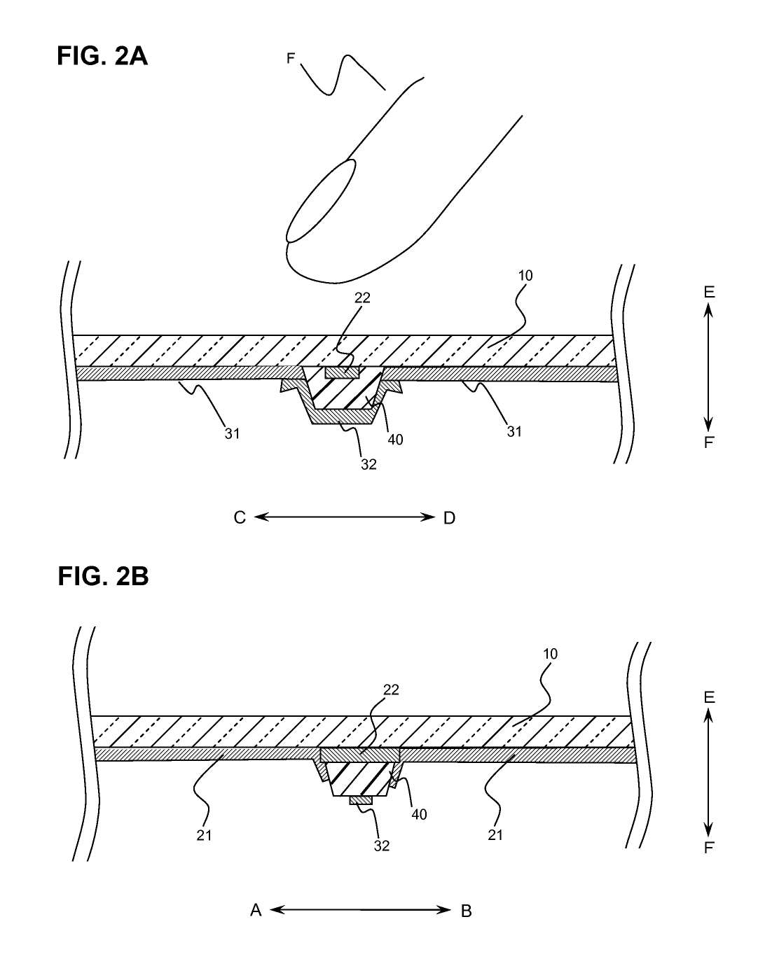

The first connection electrode 22 has a role to electrically connect the adjacent first detection electrodes 21 to each other. The first connection electrode 22 is provided in the input region E_{I} and is provided on the base body 10. As shown in FIGS. 2A and 2B, the first connection electrode 22 is opposed to a second connection electrode 32 with the electrode insulation film 40 interposed therebetween. That is, the first connection electrode 22 intersects with the second connection electrode 32 in planar view. In addition, an area of the first connection electrode 22 in planar view is smaller than an area of the first detection electrode 21 in planar view. The first detection electrode pattern 20 intersects with the second detection electrode pattern 30 at connection electrodes of which an area is smaller than an area of detection electrodes. Accordingly, the intersection region of the detection electrode patterns can be small. Thus, a floating charge at the intersection region of the detection electrode patterns can be small, so that detection accuracy of the input device X1 can be improved. The first connection electrode 22 is formed of the same material as that of the first detection electrode 21. The first connection electrode 22 can be formed by the same method as that of the first detection electrode 21.

The first wiring conductor 23 has a role to apply a voltage to the first detection electrode 21. The first wiring conductor 23 is provided in the outside region E_{O} and provided on the base body 10. One end of the first wiring conductor 23 is electrically connected to the first detection electrode 21 positioned at the end among the first detection electrodes 21, and the other end thereof is positioned in the external connection region 11.

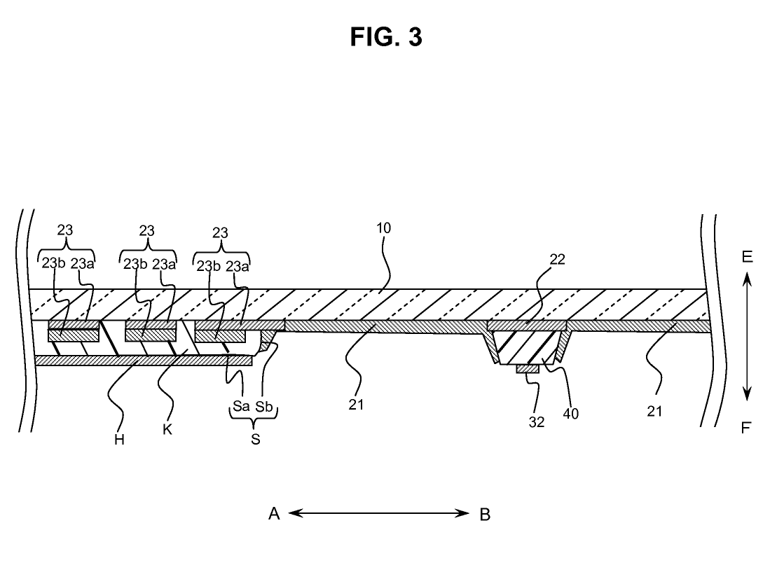

The first wiring conductor 23 is formed of a material having conductivity such as aluminum, chrome, gold, silver, copper or an alloy of them, or the same material as that of the first detection electrode 21. As shown in FIG. 3, the first wiring conductor 23 is provided in such a manner that a metal film 23b formed of aluminum, aluminum alloy, silver, or silver alloy, is laminated on a conductor pattern 23a formed of a translucent material such as ITO. Thus, the first wiring conductor 23 is low in resistance value, and a current is likely to flow therein, and detection speed of an input position is improved. The first wiring conductor 23 can be formed by the same method as that of the first detection electrode 21.

The wiring insulation film K is provided on the base body 10 so as to cover the first wiring conductor 23. In addition, the wiring insulation film K is provided in the outside region E_{O} and is provided on the base body 10. The wiring insulation film K is formed of a resin such as an acrylic resin, or epoxy resin.

The wiring insulation film K is formed by applying the above material onto the base body 10, and then exposing and developing it. If a foreign material such as dust comes to be mixed in the above material during forming the wiring insulation film K, a hole could be generated in the wiring insulation film K due to the foreign material when hardening the material to form the wiring insulation film K. As a result, water in the air could enter the wiring insulation film K through the hole and comes in contact with the first wiring conductor 23, and the first wiring conductor 23 could become eroded. Similarly, in a process for forming the first and the second detection electrode patterns 20 and 30, if a chemical solution such as an etching solution enters the hole and the etching solution comes in contact with the first wiring conductor 23, the first wiring conductor 23 could become eroded.

In a case that pigment particles are included in the wiring insulation film K, a depth of the hole can be smaller. Therefore, the chemical solution is less likely to come in contact with the first wiring conductor. As a result the first wiring conductor 23 is less likely to be eroded.

The conductor film H is formed of a conductive material such as aluminum, chrome, gold, silver, copper, or an alloy of them or the same material as that of the first detection electrode 21.

In addition, the conductor film H is provided on the wiring insulation film K so as to be opposed to the first wiring conductor 23 in a thickness direction of the wiring insulation film K. Therefore, an electric field generated from a display device, which may cause a noise to the first wiring conductor 23, is absorbed by the conductor film H, and an influence of a noise on the first wiring conductor 23 can be reduced. Therefore, the detection accuracy of the input position is improved.

The conductor film H is preferably connected to a conductor having a reference potential such as the ground potential. In this case, if the input device X1 is incorporated in the display device, the noise generated in the first wiring conductor 23 is further reduced.

In addition, when the wiring insulation film K is formed of the resin, the wiring insulation film K is likely to absorb water in the air. Therefore, if the absorbed water comes in contact with the first wiring conductor 23, the first wiring conductor 23 could become eroded. However, since the conductor film H is provided on the wiring insulation film K in the input device X1, the water in the air is less likely to be absorbed by the wiring insulation film K, and the first wiring conductor 23 is less likely to be eroded.

The conductor film H is preferably provided so as to cover the first wiring conductor 23 in planar view. Thus, the first wiring conductor 23 is less likely to be affected by the electric field generated from the display device, and the wiring insulation film K is less likely to absorb the water in the air. In addition, it is further preferable that the conductor film H is provided on a whole surface S including a main surface Sa and an end surface Sb of the wiring insulation film K.

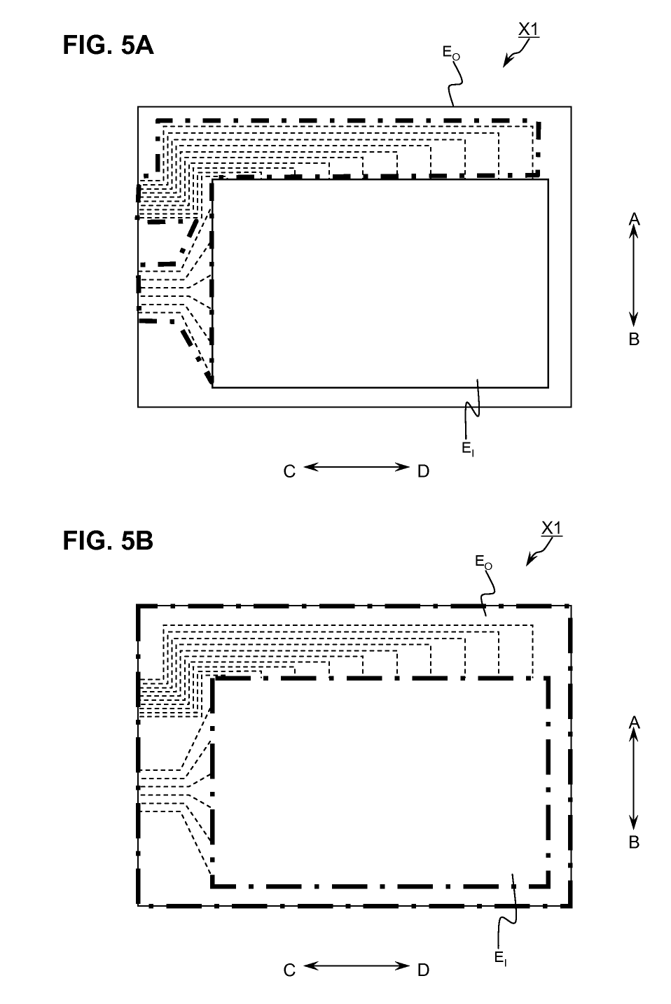

As long as the wiring insulation film K is provided in a region surrounded by a chain line in FIG. 5A, that is, a region in which the first wiring conductor 23 and the second wiring conductor 33 are formed, any pattern or shape of the wiring insulation film K is applicable. It is preferable that the wiring insulation film K is provided on the whole region of the outside region Eo like a region surrounded by a chain line in FIG. 5B because the input device is improved in flatness.

As long as the conductor film H is provided in the region in which the first wiring conductor 23 and the second wiring conductor 33 are formed, any pattern or shape of the conductor film H is applicable. It is preferable that the conductor film H is formed in the region surrounded by the chain line in FIG. 5A or 5B, that is, in the same region as that of the wiring insulation film K because the wiring insulation film K is much less likely to absorb the water in the air.

In addition, the conductor film H is preferably formed of the same material as that of the first detection electrode 21 and the second detection electrode 31. In this case, the first detection electrode 21, the second detection electrode 31, and the conductor film H can be formed in the same process. Therefore, the number of production steps of the input device X1 can be reduced.

The second detection electrode pattern 30 has a second detection electrode 31, the second connection electrode 32, and the second wiring conductor 33.

The second detection electrode 31 has a role to detect a position of the finger F moving closer to the input device X1 in the arrow direction AB. The second detection electrode 31 is provided in the input region E_{I} and is provided on the base body 10. The second detection electrodes 31 are arranged along the arrow direction AB and the arrow direction CD at intervals in the shape of a matrix, and the second detection electrodes 31 adjacent to each other in the arrow direction CD are electrically connected to each other by the second connection electrode 32. The second detection electrode 31 is in the shape of a diamond in planar view. The second detection electrode 31 is formed of the same material as that of the first detection electrode 21. In addition, a method of forming the second detection electrode 31 is the same as that of the first detection electrode 21.

The second connection electrode 32 has a role to electrically connect the adjacent second detection electrodes 31 to each other. The second connection electrode 32 is provided in the input region E_{I} and is provided on the base body 10. As shown in FIGS. 2A and 2B, the second connection electrode 32 is opposed to the first connection electrode 22 with the electrode insulation film 40 interposed therebetween. The second connection electrode 32 is formed of the same material as that of the first detection electrode 21. In addition, a method of forming the second connection electrode 32 is the same as that of the first detection electrode 21.

The second wiring conductor 33 has a role to apply a voltage to the second detection electrode 31. The second wiring conductor 33 is provided on the base body 10. One end of the second wiring conductor 33 is electrically connected to the second detection electrode 31 positioned at the end among the second detection electrodes 31, and the other end thereof is positioned in the external connection region 11. In addition, the second wiring conductor 33 is formed of the same material as that of the first wiring conductor 23. Furthermore, a method of forming the second wiring conductor 33 is the same as that of the first detection electrode 21.

Like the first wiring conductor 23, the second wiring conductor 33 is covered with the wiring insulation film K. In addition, the conductor film H is formed on the wiring insulation film K.

The electrode insulation film 40 has a role to insulate the first connection electrode 22 and the second connection electrode 32. The electrode insulation film 40 is provided on the base body 10, and positioned between the first connection electrode 22 and the second connection electrode 32. The electrode insulation film 40 is formed of the same material as that of the wiring insulation film K. In addition, a method of forming the electrode insulation film 40 is the same as that of the wiring insulation film K.

Regarding the input device X1, the conductor film H is provided on the wiring insulation film K so as to be opposed to the first wiring conductor 23 and the second wiring conductor 33 in the thickness direction of the wiring insulation film K. Therefore, since the electric field generated from the display device is absorbed by the conductor film H, a noise generated in the first wiring conductor 23 and the second wiring conductor 33 is reduced. Thus, the detection accuracy of the input position can be improved.

In addition, the conductor film H can reduce the water absorbed in the wiring insulation film K, and the first wiring conductor 23 and the second wiring conductor 33 can be less likely to be eroded.

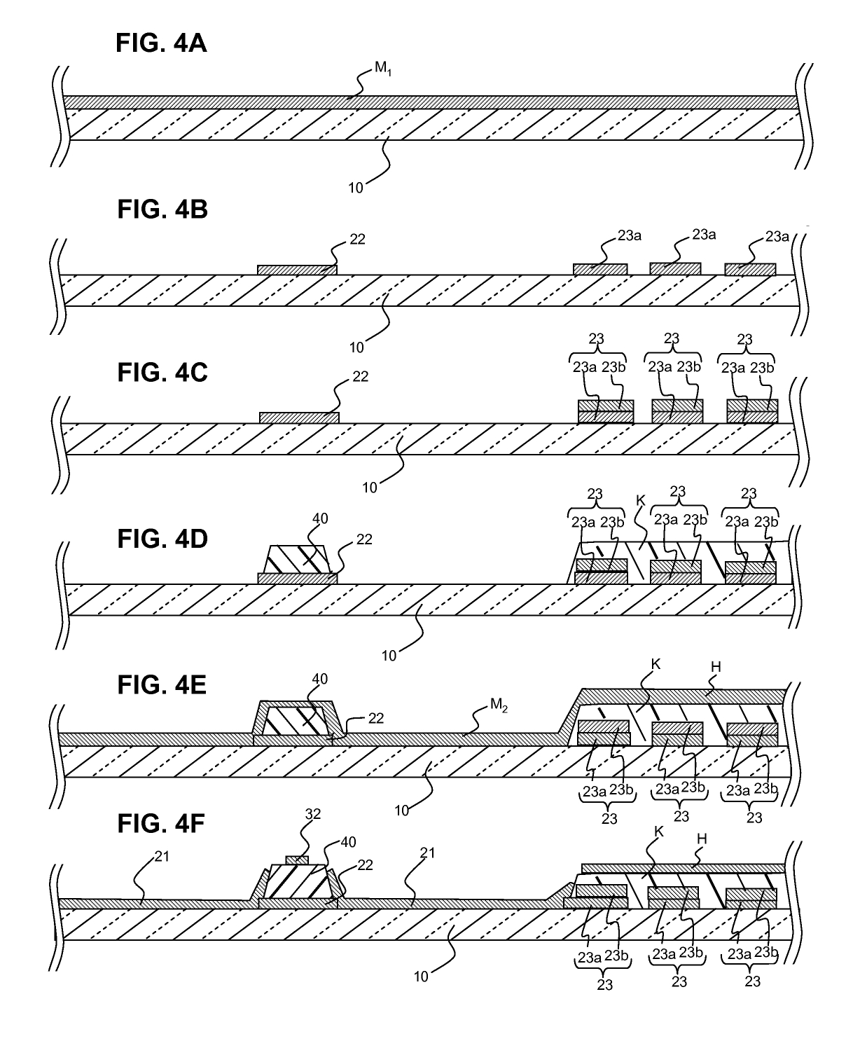

Next, a method of producing the input device X1 is described with reference to FIGS. 4A to 4F. FIGS. 4A to 4F are cross-sectional views showing production steps taken along a line IIIb-IIIb in FIG. 1.

As shown in FIG. 4A, a film M₁ is formed of a translucent material such as ITO on the base body 10 by the sputtering method. Then, a photosensitive resin is applied onto a surface of the film M₁, and the film M₁ is patterned as shown in FIG. 4B through exposing, developing, and etching steps, and a step of removing the photosensitive resin. Thus, the first connection electrode 22 and the conductor pattern 23a are formed.

Then, a metal film formed of aluminum is formed on the base body 10 and patterned in the same way as the above. Thus, as shown in FIG. 4C, the conductor pattern 23a is covered with the metal film 23b, whereby the first wiring conductor 23 having a laminated structure is formed.

Then, an insulation material such as an acrylic resin is applied to the base body 10, and exposed, developed, and hardened. Thus, as shown in FIG. 4D, the electrode insulation film 40 is formed on the first connection electrode 22, and the wiring insulation film K is formed on the first wiring conductor 23. If a foreign material such as dust is contained in the insulation material in this step, a hole could be formed in the wiring insulation film K when hardening the insulation material due to the foreign material.

Then, as shown in FIG. 4E, a film M₂ is formed of a translucent material such as ITO on the base body 10. At the same time, the conductor film H is formed on the wiring insulation film K so as to be opposed to the first wiring conductor 23.

Then, the film M₂ is patterned. At the time of patterning, an etching solution to etch away a part of the film M₂ comes over to the wiring insulation film K. However, even when the hole is generated in the wiring insulation film K, the etching solution is less likely to enter the hole of the wiring insulation film K because the conductor film H is formed on the wiring insulation film K. That is, the etching solution is less likely to come in contact with the first wiring conductor 23.

Through the above production steps, the input device X1 is produced as shown in FIG. 4F.

In addition, the production method of the input device X1 is not limited to this. While the film M₂ and the conductor film H are formed at the same time in the above production method, the film M₂ may be formed and patterned after the conductor film H has been formed.

The conductor film H is provided on the wiring insulation film K so as to be opposed to the first wiring conductor 23 and the second wiring conductor 33 in the thickness direction of the wiring insulation film K. Therefore, even when the hole is generated in the wiring insulation film K due to a foreign material such as dust, the etching solution can be less likely to come in contact with the first wiring conductor 23 and the second wiring conductor 33 due to the conductor film H. As a result, the first wiring conductor 23 and the second wiring conductor 33 can be less likely to be eroded.

In addition, in the input device X1, the first detection electrode 21 and the second detection electrode 31, and the conductor film H are formed of the same material. Thus, the first detection electrode 21 and the second detection electrode 31, and the conductor film H can be formed in the same process. As a result, the number of production steps of the input device X1 can be reduced, and productivity of the input device X1 can be improved.

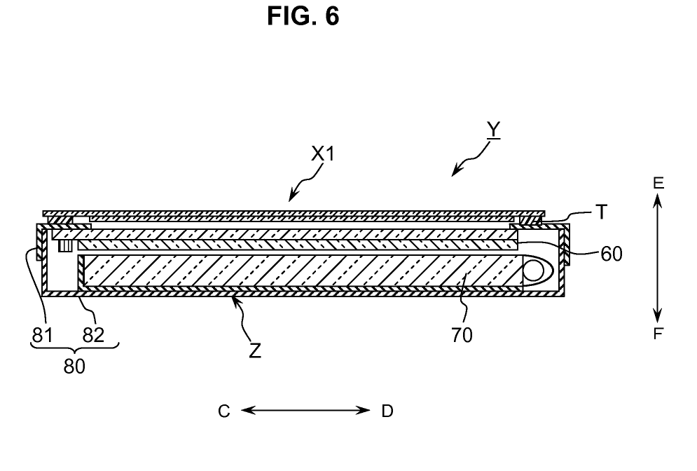

As shown in FIG. 6, a display device Y is composed of the input device X1 and a liquid crystal display device Z. In addition, the liquid crystal display device Z is composed of a liquid crystal display panel 60, a light source device 70, and a case 80.

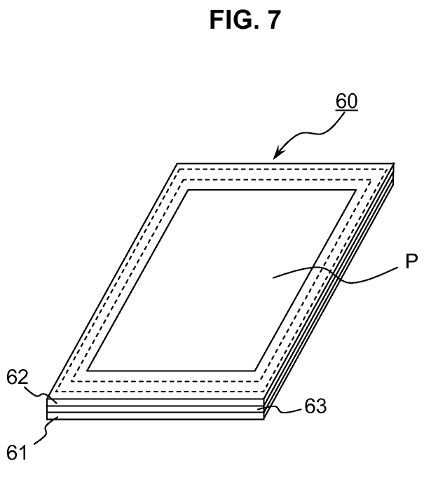

As shown in FIG. 7, the liquid crystal display panel 60 is composed of a first base body 61, a second base body 62, and a sealing member 63, and a display region P composed of a plurality of pixels to display an image is formed by interposing a liquid crystal layer (not shown) between the first base body 61 and the second base body 62, and sealing the liquid crystal layer with the sealing member 63.

The light source device 70 has a role of applying light toward the liquid crystal display panel 60, and arranged between the liquid crystal display panel 60 and a lower case 82.

The case 80 is a member to house the liquid crystal display panel 60 and the light source device 70, and has an upper case 81 and the lower case 82. A material of the case 80 includes a resin such as a polycarbonate resin, or metal such as stainless (SUS) or aluminum.

The input device X1 and the liquid crystal display device Z are bonded with a double-faced tape T. In addition, a fixing member used to fix the input device X1 and the liquid crystal display device Z is not limited to the double-faced tape T, so that it may be a bonding member such as a thermosetting resin or ultraviolet curable resin, or a fixing body to physically fix the input device X1 and the liquid crystal display device Z.

In addition, the conductor film H of the input device X1 is positioned closer to the liquid crystal display panel 60 than the first wiring conductor 23 and the second wiring conductor 33. Therefore, the electric field generated from the liquid crystal display panel 60 is absorbed by the conductor film H before it reaches the first wiring conductor 23 and the second wiring conductor 33, and the detection accuracy of the input position can be much less likely to be lowered.

The display device Y is provided with the input device X1 as described above. As a result, the first wiring conductor 23 and the second wiring conductor 33 can be less likely to be eroded.

### Second Embodiment

Next, an input device X2 according to a second embodiment of the present invention is described. The same references are assigned to the components having the same functions as those of the input device X1, and a description which overlaps with the input device X1 is omitted.

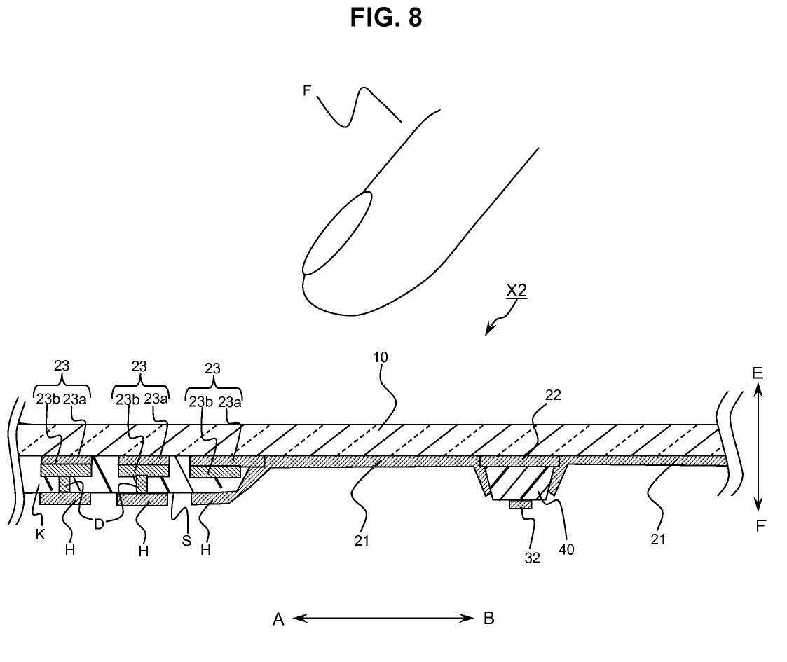

As shown in FIG. 8, regarding the input device X2, a plurality of conductor films H are provided on a wiring insulation film K so as to be spaced with each other.

In addition, the plurality of conductor films H are spaced with each other, and opposed to each of first wiring conductors 23 to be electrically connected to them. Therefore, since a potential difference between the first wiring conductor 23 and the conductor film H opposed to the first wiring conductor 23 can be small, a floating charge between the first wiring conductor 23 and the conductor film H can be reduced. As a result, detection accuracy of an input position of the input device X2 is improved.

In addition, regarding the input device X2, two wiring conductors 23 on the side of an arrow direction A among three first wiring conductors 23 shown in FIG. 8 are each electrically connected to the opposed conductor films H through conduction through holes D. Meanwhile, a part of the first wiring conductor 23 on the side of an arrow direction B shown in FIG. 8 is not covered with the wiring insulation film K. The first wiring conductor 23 can be electrically connected to the conductor film H at the part not covered with the wiring insulation film K. Thus, since it is not necessary to provide the conduction through hole D there, productivity of the input device X2 is improved.

In addition, the first wiring conductor 23 and the conductor film H are electrically connected in the input device X2, but the conductor film H and the first wiring conductor 23 are not in contact with each other. Thus, an electric field from the display device Y can be less likely to affect the first wiring conductor 23 when the input device X2 is incorporated in the display device. In addition, when the conductor film H is set to a reference potential such as the ground potential, the electric field can be much less likely to affect the first wiring conductor 23.

In addition, since the conductor film H is provided on the wiring insulation film K in the input device X2, the wiring insulation film K is less likely to absorb water in the air, therefore, the first wiring conductor 23 can be less likely to be eroded.

In addition, the same effect can be provided in the display device Y even when the input device X2 is employed therein instead of the input device X1.

Furthermore, the above embodiments are specific embodiments of the present invention, and various kinds of variations can be employed. Hereinafter, several variations are shown.

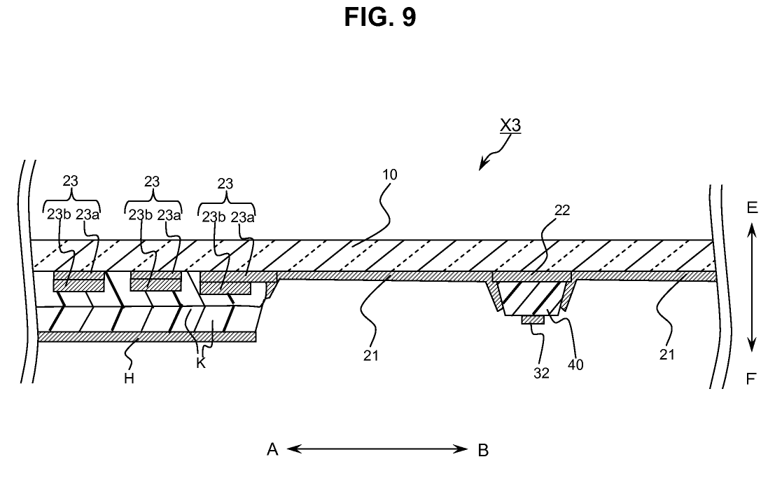

Regarding an input device X3, as shown in FIG. 9, a plurality of wiring insulation films K are provided on a base body 10 so as to cover a first wiring conductor 23. Thus, a hole is less likely to be formed in the wiring insulation film K due to a foreign material such as dust. Therefore, the possibility that the first wiring conductor 23 becomes eroded can be further reduced.

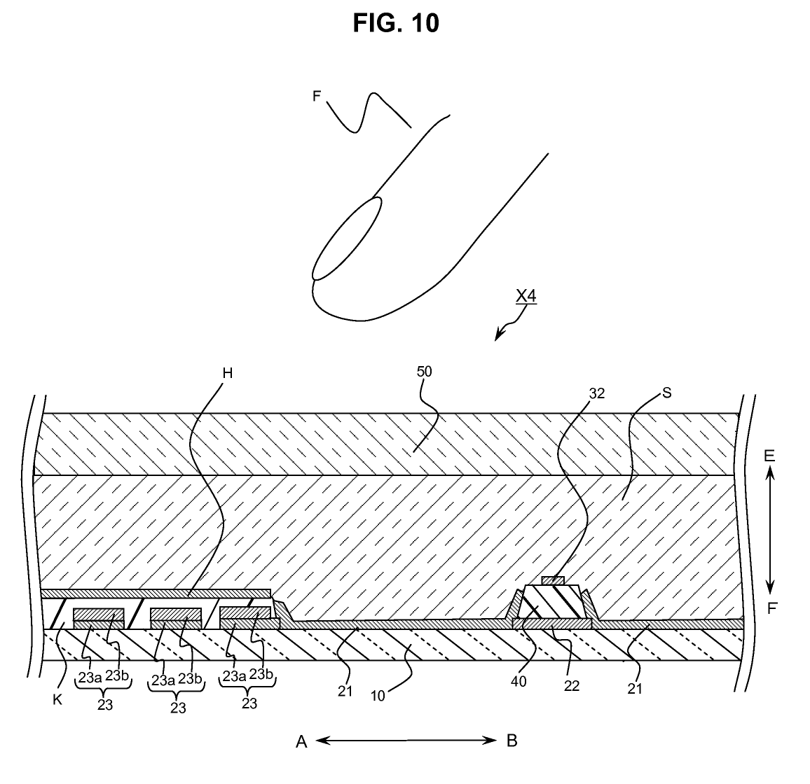

Regarding an input device X4, as shown in FIG. 10, a protection substrate 50 is arranged so as to be opposed to a base body 10. The protection substrate 50 has a function to prevent an external substance from directly coming in contact with a first detection electrode pattern 20 and a second detection electrode pattern 30. The protection substrate 50 is formed of a material having preferable translucency to visible light such as well-known acrylic plate, glass plate, PET film, or polarization plate.

In addition, the base body 10 and the protection substrate 50 are bonded with a bonding member S. The bonding member S is formed of a translucent resin such as an acrylic resin, epoxy resin, or silicon resin.

In addition, while the first detection electrode pattern 20 and the second detection electrode pattern 30 are provided on the one base body 10 in the input device X1, the present invention is not limited to this. For example, two base bodies may be provided, and the first detection electrode pattern 20 may be provided on one of base bodies, and the second detection electrode pattern 30 may be provided on the other thereof.

In addition, the present invention can be applied to a resistive touch panel using an analog resistance film as well as a resistive touch panel using a matrix resistance film.

In addition, while the case where the display device Y is provided with the input device X1 is described in the above, the input devices X3 and X4 may be employed therein instead of the input device X1.

Furthermore, while the case where the display panel is the liquid crystal display panel in the display device Y is described in the above, the present invention is not limited to this. More specifically, the display panel may be a CRT, plasma display, organic EL display, inorganic EL display, LED display, fluorescent display tube, field emission display, and surface-conduction electron-emitter display.

What is claimed is:

1. An input device having an input region and an outside region positioned outside the input region and comprising:
a base body having translucency;
a detection electrode configured to detect an input position, the detection electrode provided in the input region and provided on the base body;
a wiring conductor configured to apply a voltage to the detection electrode, the wiring electrode provided in the outside region and provided on the base body;
an insulation film which covers the wiring conductor and is provided in the outside region; and
a conductor film provided on the insulation film so as to be opposed to the wiring conductor in a thickness direction of the insulation film.

2. The input device according to claim 1, wherein
the plurality of wiring conductors are provided in the outside region and are provided on the base body,
the wiring conductors are apart from each other,
the insulation film covers the wiring conductors and is provided in the outside region,
the plurality of conductor films are provided on the insulation film,
the conductor films are apart from each other and opposed to the respective wiring conductors in the thickness direction of the insulation film, and electrically connected to the respective opposed wiring conductors.

3. The input device according to claim 1, wherein
the conductor film covers the wiring conductor in planar view.

4. The input device according to claim 1, wherein
the conductor film is connected to a reference conductor having a reference potential.

5. The input device according to claim 1, wherein
the insulation film contains pigment particles.

6. A display device comprising:
the input device according to claim 1, and
a display panel arranged so as to be opposed to the input device, wherein
the conductor film of the input device is positioned closer to the display panel than the wiring conductor.

7. The display device according to claim 6, wherein
the display panel is a liquid crystal display panel.
